(19) United States
(12) Patent Application Publication
(10) Pub. No.: US 2025/0201431 A1
(43) Pub. Date: Jun. 19, 2025

(54) FLOW CONDITIONING DEVICE FOR STEAM GENERATOR

(71) Applicant: Westinghouse Electric Company LLC, Cranberry Township, PA (US)

(72) Inventors: Creed Taylor, Signal Mountain, TN (US); Jason D. Burr, Cranberry Township, PA (US)

(73) Assignee: Westinghouse Electric Company LLC, Cranberry Township, PA (US)

(21) Appl. No.: 18/847,350

(22) PCT Filed: Mar. 15, 2023
(86) PCT No.: PCT/US2023/064375

§ 371 Date: Sep. 16, 2024

Related U.S. Application Data
(60) Provisional application No. 63/269,363, filed on Mar. 15, 2022.

(51) Int. Cl. G21D 1/00; F22B 1/16; F22B 37/00

(52) U.S. Cl. CPC G21D 1/006; F22B 1/162; F22B 37/002

(57) ABSTRACT

Disclosed is an apparatus and method for conditioning fluid flow in a nuclear power plant steam generator. A flow conditioning device includes an outer enclosure defining a plurality of entrance apertures arranged in an array and a plurality of exit apertures arranged in an array. A plurality of baffle plates are defined within the outer housing. The baffle plates define flow channels in fluid communication with the entrance and exit apertures to create a flow path of alternating directions. The flow channels receive fluid flow from the plurality of entrance apertures, direct the fluid flow from the entrance apertures in alternating directions through the flow channels to impart turning and frictional pressure loss to the fluid flow, and direct exiting fluid flow through the exit apertures into the tubelane region of the steam generator.

### CROSS-REFERENCE TO RELATED APPLICATION

This application is a U.S. National Stage Entry under 35 U.S.C. § 371 of International Patent Application No. PCT/US2023/064375, entitled FLOW CONDITIONING DEVICE FOR STEAM GENERATOR, filed Mar. 15, 2023, which claims the benefit of and priority under 35 U.S.C. § 119 (e) to U.S. Provisional Application Ser. No. 63/269,363 filed Mar. 15, 2022, entitled “FLOW CONDITIONING DEVICE FOR STEAM GENERATOR,” the contents of which are hereby incorporated by reference in their entirety herein.

### BACKGROUND

The present disclosure is directed to a flow conditioning device for use in a steam generator. More particularly, the present disclosure is directed to a flow conditioning device for use in a nuclear power steam generator. More particularly, the present disclosure is directed to a flow conditioning device structurally attached to a tube support plate disposed in a tubelane region of a steam generator.

Current steam generator designs for nuclear power plants generate high fluid velocities in the tubelane region. The high fluid velocity may induce tube vibration and wear at the tube support plates in the tubelane region near drilled plate flow holes.

A novel flow conditioning device for use with a broached tube support plate design to address these issues is disclosed herein. The flow conditioning device is disposed in the tubelane region of a steam generator and is distinct from other known designs in performance capability and configuration. The flow conditioning device improves fluid conditions in the vicinity of low radius U-bend tubes portion of the steam generator tube bundle. The flow conditioning device increase the fluid flow resistance, reduces the fluid flow velocity, and reduces vibration and wear at the tube support plates in the tubelane region. Such flow conditioning device for use with a broached tube support plate design is disclosed hereinbelow.

### SUMMARY

In various instances, the present disclosure provides A flow conditioning device for use in a nuclear power plant steam generator, the flow conditioning device comprising: an outer enclosure defining a plurality of entrance apertures arranged in an array and a plurality of exit apertures arranged in an array; a plurality of baffle plates defined within the outer housing, wherein the baffle plates define flow channels in fluid communication with the entrance and exit apertures, and wherein the flow channels create a flow path of alternating directions; and wherein the flow channels: receive fluid flow from the plurality of entrance apertures; direct the fluid flow from the entrance apertures in alternating directions through the flow channels to impart turning and frictional pressure loss to the fluid flow; and direct exiting fluid flow through the exit apertures into the tubelane region of the steam generator.

In various instances, the present disclosure provides a method for increasing local hydraulic resistance in a tubelane region of a nuclear power plant steam generator, the method comprises a plurality of entrance apertures defined by an outer enclosure receive fluid flow. The entrance apertures are arranged in an array and are in fluid communication with the tubelane region of the steam generator. The fluid flow is directed from the entrance apertures in alternating directions through flow channels defined by a plurality of baffle plates defined within the outer housing. The flow channels impart turning and frictional pressure losses to the fluid flow through the flow channels. Exiting fluid flow is directed through exit apertures into the tubelane region of the steam generator. The plurality of exit apertures are defined by the outer enclosure and are arranged in an array.

### BRIEF DESCRIPTION OF THE DRAWINGS

The various aspects described herein, both as to organization and methods of operation, together with further objects and advantages thereof, may best be understood by reference to the following description, taken in conjunction with the accompanying drawings as follows.

FIG. 1 is an elevation view of a steam generator that includes the location of the proposed hardware implemented flow conditioning device to mitigate the wear of tube support plates near drilled flow holes in the tubelane region, according to one aspect of this disclosure.

FIG. 2 is a closer view of the location of the proposed hardware implemented flow conditioning device shown in FIG. 1.

FIG. 3 illustrates a first detailed view of the enveloping installed location of a flow conditioning device, according to one aspect of this disclosure.

FIG. 4 illustrates a second detailed view of the enveloping installed location of a flow conditioning device shown in FIG. 3, according to one aspect of this disclosure.

FIG. 5 illustrates a section view of the flow conditioning device shown in FIGS. 3 and 4, according to one aspect of this disclosure.

FIG. 6 is a schematic view of the flow conditioning device shown in FIGS. 3-5, according to one aspect of this disclosure.

Corresponding reference characters indicate corresponding parts throughout the several views. The exemplifications set out herein illustrate various disclosed embodiments, in one form, and such exemplifications are not to be construed as limiting the scope thereof in any manner.

### DESCRIPTION

Before explaining various aspects of flow conditioning devices disposed in the tubelane region of a nuclear power steam generator in detail, it should be noted that the illustrative examples are not limited in application or use to the details of construction and arrangement of parts illustrated in the accompanying drawings and description. The illustrative examples may be implemented or incorporated in other aspects, variations and modifications, and may be practiced or carried out in various ways. Further, unless otherwise indicated, the terms and expressions employed herein have been chosen for the purpose of describing the illustrative examples for the convenience of the reader and are not for the purpose of limitation of expressions of aspects, and/or examples, can be combined with any one or more of the other following-described aspects, expressions of aspects and/or examples.

For some larger steam generator designs, it has been determined by study that a “drilled plate” flow hole type configuration of a top tube support plate provides insufficient hydraulic resistance to reduce fluid flow velocities in the tubelane region to levels needed to meet design requirements. It has been determined that completely blocking flow in the tubelane region (eliminating flow holes and slots altogether) may create undesirable issues such as vortices and stagnation zones in the tube bundle. The description below discloses a flow conditioning device attached to a broached tube support plate to increase the local hydraulic resistance to reduce the fluid flow velocities in the tubelane region of the steam generator.

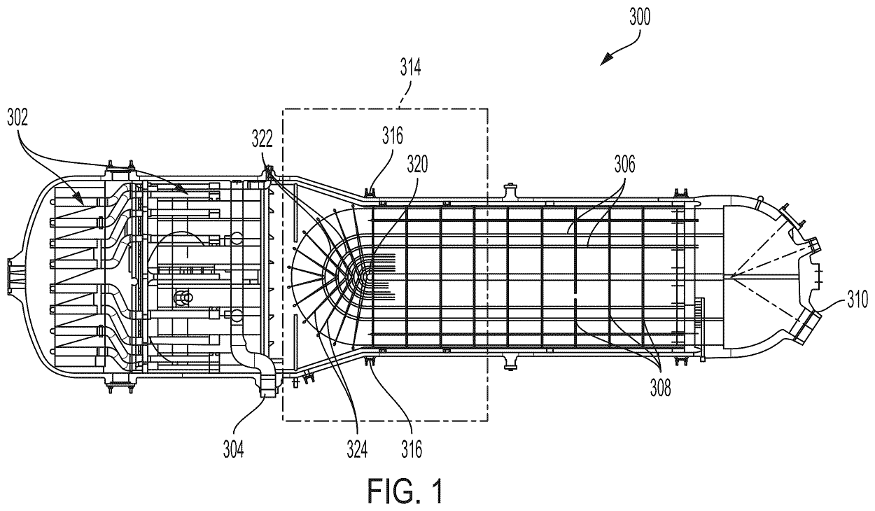

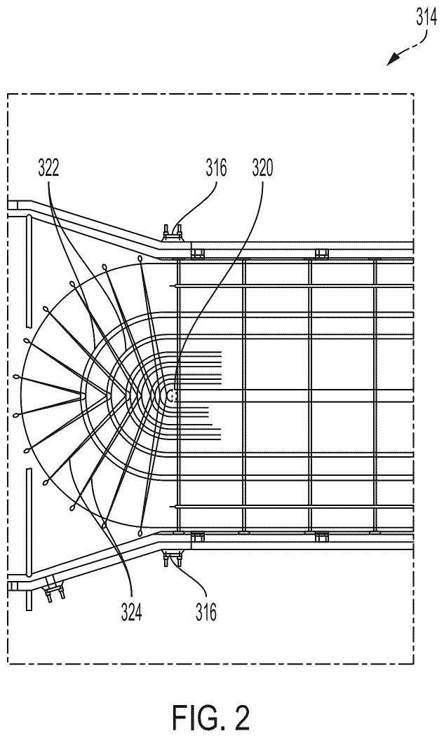

The description now turns to FIG. 1, which is an elevation view of a steam generator 300 that includes a proposed hardware implemented flow conditioning device 320 (FCD) to mitigate tube wear at tube support plates 308 (TSP) intersections near the drilled flow holes in the tubelane region, according to one aspect of this disclosure. A close-up section 314 shows the location of the proposed hardware implemented FCD 320 is shown in FIG. 2. Various aspects of a FCD 320 to increase the hydraulic resistance of the fluid flowing in the tubelane region 330 is described herein with reference to 1-6.

With reference now to FIGS. 1 and 2, the steam generator 300 includes steam separators 302, a feed water inlet nozzle 304, a tube bundle 306, and a plurality TSPs 308. The steam generator 300 also includes a primary inlet nozzle 310 and a primary outlet nozzle (not shown). With reference in particular to the detail section 314, the steam generator 300 further includes hand hole access ports 316 inline with the tubelane above the plurality of TSPs 308. In the illustrated example, the hand hole access ports 316 are located inline with the tubelane above TSP 10 (“K” plate). The FCD 320 is disposed in the tubelane region of the steam generator 300 in the center of the U-bend tubes 322, which are supported by additional u-bend supports called anti-vibration bars 324.

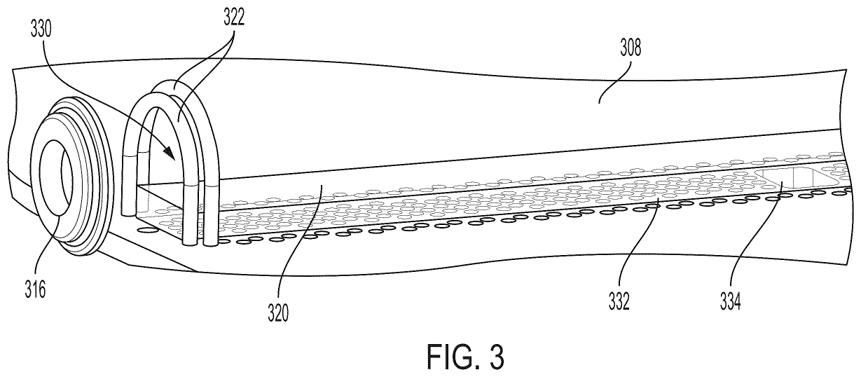

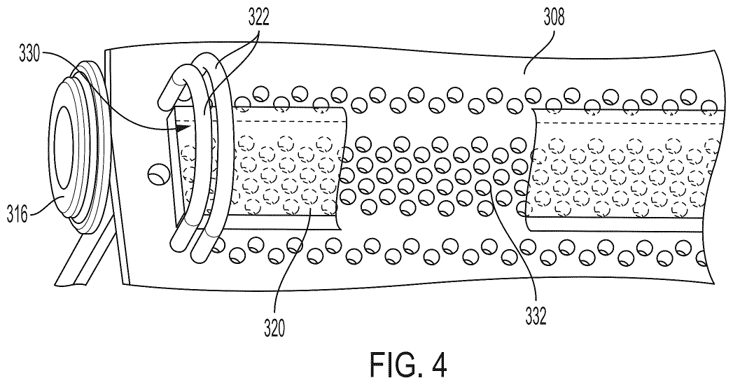

FIGS. 3 and 4 illustrate first and second views of the FCD 320, according to one aspect of this disclosure. With reference to FIGS. 3 and 4, the FCD 320 is installed on the top TSP 308. The tubelane region 330 is accessed through the inline hand hole access port 316. The hand hole access port 316 may be closed off with a wrapper plug, which is not shown for clarity of disclosure. Also shown are Row 1 and Row 2 of the U-bend tubes 322 that define the tubelane region 330. The other U-bend tubes 322 of the tube bundle 306 are not shown for clarity of disclosure. The FCD 320 is structurally attached to the TSP 308 and is located over the drilled plate flow holes 332 and flow slot 334 in the tubelane region 330.

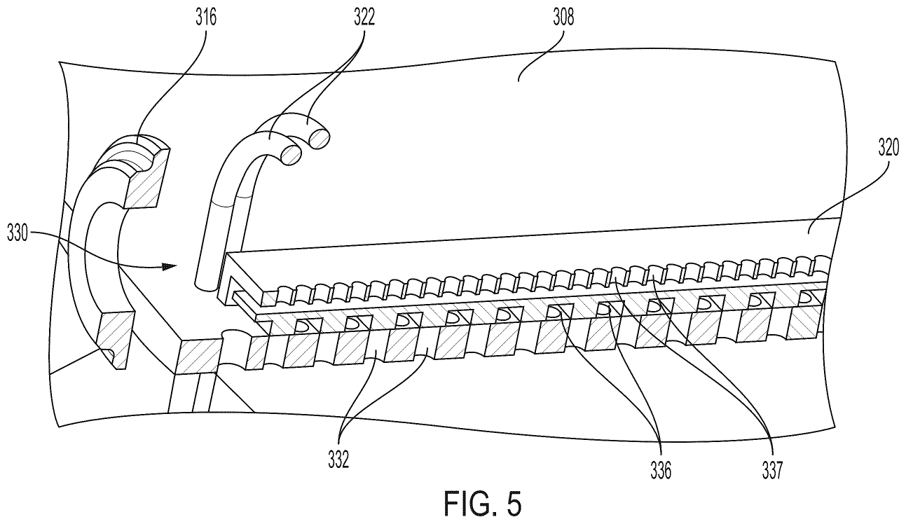

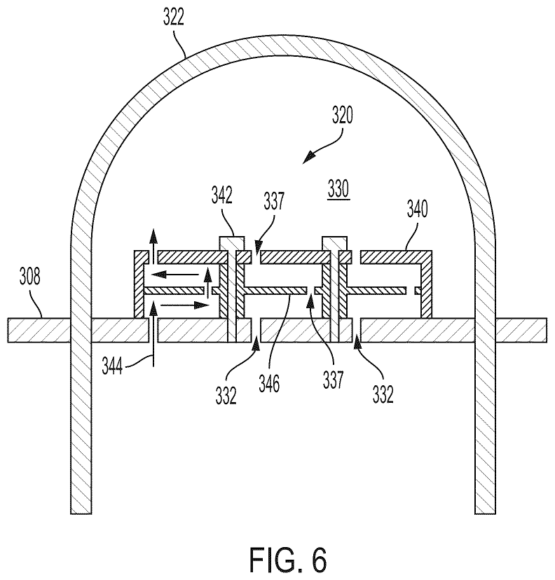

The tubelane region 330 of the TSP 308 (also described below in FIGS. 5-6) often provides lower hydraulic resistance than the rest of the TSP 308 (broached region) and generally results in higher local fluid velocity in the tubelane region 330. The fluid velocity exiting the top TSP 308 tubelane region is in close proximity to the U-bend portion of the low row U-bend tubes 322 portion of the tube bundle 306.

With reference to FIGS. 1-6, to mitigate the high fluid velocity near the TSP 308 in the tubelane region 330 near the drilled plate flow holes 332 (FIGS. 3-6), the present disclosure provides a hardware implemented FCD 320 to improve flow conditioning in the vicinity of low radius U-bend tubes 322 portion of the tube bundle 306. The disclosed FCD 320 does not completely block fluid flow in the vicinity of the low radius U-bend tubes 322, but rather increase the fluid flow resistance and reduces the fluid flow velocity, minimizes risks with unintended flow anomalies, and minimizes impacts to interfacing systems, hardware, analysis, etc. In one aspect, the disclosed FCD 320 is introduced through existing pressure boundary penetrations, such as the secondary side inspection ports, referred to herein as hand hole access ports 316, for example. The FCD 320 implementation allows modifications to be performed while the steam generator 300 is being manufactured without requiring significant disassembly/rework.

FIG. 5 illustrates a section view of the FCD 320, according to one aspect of this disclosure. The FCD 320 includes entrance apertures 336 in fluid communication with the drilled plate flow holes 332 in the tubelane region 330. The entrance apertures 336 receive fluid flow from the drilled plate flow holes 332 and direct the fluid flow in alternating directions through internal channels or passages defined by baffle plates 346 (shown schematically in FIG. 6). The redirection of the fluid flow by the internal channels defined by the baffle plates 346 imparts turning and frictional pressure losses to the fluid flow and reduced the fluid flow velocity. The fluid flow is directed by the internal baffle plates 346 to exit apertures 337, which direct the exiting fluid flow into the tubelane region 330 of the steam generator 300. The internal baffle plates 346 increase the hydraulic resistance of the fluid flow over the rest of the TSP 308 (broached region) to generally lower the local fluid velocity in the tubelane region 330.

FIG. 6 is a schematic view of the FCD 320 shown in FIGS. 3-5, according to one aspect of this disclosure. The FCD 320 includes an outer enclosure 340 structurally attached to the TSP 308 by a mechanical fastener 342, such as a threaded fastener, or any other suitable mechanical fastener. The FCD 320 is structurally connected to the TSP 308 using mechanical fasteners such as threaded bolts, or any other suitable mechanical fastener.

Still referring to FIG. 6, in the tubelane region 330, the TSP 308 defines flow holes 332 drilled through the plate to provide a fluid flow path 344 as indicated by the arrows. The fluid flows through the flow holes 332 and is received through the entrance apertures 336. Internal flow baffle plate(s) 346 are in fluid communication with the entrance apertures 336 and are arranged in a regular array to direct entering fluid flow into the FCD 320. The internal baffle plates 346 guide the fluid flow through the exit apertures 337 into the tubelane region 330. The fluid flow path 344 defined by the arrows increases the hydraulic resistance of the fluid flow to reduce the velocity of the fluid flow exiting the exit apertures 337.

Still with reference to FIG. 6, the FCD 320 may be adapted and configured for targeted adjustment of local hydraulic resistance in a nuclear steam generator 300 tube bundle 306. In one aspect, the FCD 320 may be formed of solid construction of one or more functional parts and comprises an outer enclosure 340, internal flow baffle plate(s) 346, and threaded fasteners 342 for structural attachment to the TSPs 308. The outer enclosure 340 defines a plurality of entrance aperture 336 arranged in a regular array that direct entering fluid flow into the FCD 320. The baffle plate(s) 346 and the plurality of entrance apertures 336 arranged in a regular array create flow channels or passages of alternating direction as shown by the fluid flow path 344 defined by the arrows, which impart turning and frictional pressure losses to the fluid flow. The plurality of entrance apertures 336 defined by the outer enclosure 340 are arranged in a regular array to direct exiting flow into the tube bundle 306 at a desired velocity magnitude and direction. In one aspect, the FCD 320 may be structurally attached to the TSPs 308. In alternate aspects, however, the FCD 320 may be structurally attached to the steam generator 300 using a variety of attachment configurations.

In another aspect, the outer enclosure 340 of the FCD 320, may comprise alignment or support features designed to orient, support, or facilitate attachment of the FCD 320 to a TSP 308. In various aspects, the alignment features may comprise support pins, support inlet tubes or matched holes. In various aspects, the support features may comprise contact surfaces on the outer enclosure 340.

In another aspect, the plurality of entrance apertures 336 defined by the outer enclosure 340 of the FCD 320 are configured to align or interface with matching flow holes 332 defined by TSP 308.

In yet another aspect, the FCD 320 may be attached using an alternate method of attachment such as a hydraulic expansion type designs or interference fit type designs to attach the FCD 320 to the TSP 308 in addition to or instead of using the threaded fasteners 342.

With reference now to FIGS. 1-6, the tubelane region 330 of the TSP 308 described herein is configured to provide higher hydraulic resistance than the rest of the TSP 308 (broached region) due to the increased fluid flow path 344 defined by the arrows. This generally results in a lower local fluid velocity in the tubelane region 330. The fluid velocity exiting the top TSP 308 tubelane region 330 is in close proximity to the U-bend portion of the low row U-bend tubes 322. The local tube gap velocity is called the “effective velocity.” The tube “critical velocity” is defined as the velocity at the onset of fluidelastic vibration. The additional hydraulic resistance in the tubelane region 330 reduces the effective velocity on the U-bend portion of low row U-bend tubes 322.

Additional hydraulic resistance can be achieved using the FCD 320 specifically designed for this purpose. The FCD 320 attaches to the top TSP 308 preferably using mechanical hardware (i.e., threaded bolts); although, other suitable qualified structural attachment techniques are also possible. The FCD 320 would increase the local tubelane region 330 hydraulic resistance by incorporating sufficient minor losses to meet the desired local fluid velocity. Minor losses may include but are not limited to: frictional, turning, and change in flow area (i.e., entrance and exit).

In one aspect, the FCD 320 preferably is installed during initial fabrication of the steam generator 300 in the shop but also may be designed for field installation in a fully constructed steam generator 300.

In one aspect, the FCD 320 is designed to have low impact to the overall steam generator 300 thermal-hydraulic performance (i.e., steam pressure, circulation ratio) and targeted impact to the tube gap velocity for the U-bend portion of low row U-bend tubes 322 in the region of the top TSP 308.

In one aspect, as shown in FIGS. 3-6, the FCD 320 employs drilled offset plates inside of a channel which is bolted to the top TSP 308 in the tubelane region 330.

With reference to FIGS. 1-6, the FCD 320 described herein is different from existing or known tube support plate designs with “drilled” flow holes and slots in the tubelane region in design configuration, method of fabrication, attachment, and overall hydraulic resistance. The FCD 320 design described herein provides higher local flow resistance compared to the “drilled plate” design and results in improved “conditioning” of flow to achieve targeted velocity in the tubelane region 330 of the steam generator 300 without significant impacts to the overall thermal-hydraulic operating characteristics.

In various aspects, the FCD 320 may be installed in a variety of steam generators used in the nuclear power industry, including, for example, steam generators for PWR type nuclear reactors

Various additional aspects of the subject matter described herein are set out in the following numbered examples:
Example 1: A flow conditioning device for use in a nuclear power plant steam generator, the flow conditioning device comprising: an outer enclosure defining a plurality of entrance apertures arranged in an array and a plurality of exit apertures arranged in an array; a plurality of baffle plates defined within the outer housing, wherein the baffle plates define flow channels in fluid communication with the entrance and exit apertures, and wherein the flow channels create a flow path of alternating directions; and wherein the flow channels: receive fluid flow from the plurality of entrance apertures; direct the fluid flow from the entrance apertures in alternating directions through the flow channels to impart turning and frictional pressure loss to the fluid flow; and direct exiting fluid flow through the exit apertures into the tubelane region of the steam generator.
Example 2: The flow conditioning device of Example 1, wherein the outer enclosure is structurally attached to a tube support plate of the steam generator.
Example 3: The flow conditioning device of any one of Examples 1-2, wherein the outer enclosure comprises threaded fasteners to structurally attach the outer enclosure to the tube support plate of the steam generator.
Example 4: The flow conditioning device of any one of Example 1-2, wherein the outer enclosure is structurally attached to the tube support plate by hydraulic expansion.
Example 5: The flow conditioning device of any one of Examples 1-2, wherein the outer enclosure is structurally attached to the tube support plate by an interference fit.
Example 6: The flow conditioning device of any one of Examples 1-2, wherein the outer enclosure comprises alignment or support features to orient, support, or facilitate attachment of the outer enclosure to the tube support plate.
Example 7: The flow conditioning device of Example 6, wherein the alignment features comprise support pins, support inlet tubes, or matched holes.
Example 8: The flow conditioning device of Example 6, wherein the support features comprise contact surfaces on the outer enclosure.
Example 9: The flow conditioning device of any one of Examples 1-8, wherein the plurality of entrance apertures defined by the outer enclosure are configured to align or interface with matching flow holes defined by the tube support plate.
Example 10: A method for increasing hydraulic resistance in a tubelane region of a nuclear power plant steam generator, the method comprising: receiving fluid flow from a plurality of entrance apertures defined by an outer enclosure, wherein the entrance apertures are arranged in an array, and wherein the entrance apertures are in fluid communication with the tubelane region of the steam generator; directing the fluid flow from the entrance apertures in alternating directions through flow channels defined by a plurality of baffle plates defined within the outer housing; imparting turning and frictional pressure losses to the fluid flow through the flow channels; and directing exiting fluid flow through exit apertures into the tubelane region of the steam generator, wherein the plurality of exit apertures are defined by the outer enclosure, and wherein the plurality of exit apertures are arranged in an array.
Example 11: The method of Example 10, further comprising structurally attaching the outer enclosure to a tube support plate of the steam generator.
Example 12: The method of any one of Examples 10-11, further comprising structurally attaching the outer enclosure to the tube support plate of the steam generator with threaded fasteners.
Example 13: The method of any one of Examples 10-11, further comprising structurally attaching the outer enclosure to the tube support plate of the steam generator by hydraulic expansion.
Example 14: The method of any one of Examples 10-11, further comprising structurally attaching the outer enclosure to the tube support plate of the steam generator by an interference fit.
Example 15: The method of any one of Example 10-11, further comprising structurally attaching the outer enclosure to the tube support plate of the steam generator by aligning the outer enclosure to the outer enclosure to the tube support plate.
Example 16: The method of Example 15, further comprising aligning the outer enclosure to the outer enclosure to the tube support plate with support pins, support inlet tubes, or matched holes.
Example 17: The method of Example 15, further comprising aligning the outer enclosure to the outer enclosure to the tube support plate with contact surfaces on the outer enclosure.
Example 18: The method of any one of Examples 10-17, further comprising aligning or interfacing the plurality of entrance apertures defined by the outer enclosure with matching flow holes defined by the tube support plate.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A flow conditioning device for use in a nuclear power plant steam generator, the flow conditioning device comprising:
an outer enclosure defining a plurality of entrance apertures arranged in an array and a plurality of exit apertures arranged in an array;
a plurality of baffle plates defined within the outer housing, wherein the baffle plates define flow channels in fluid communication with the entrance and exit apertures, and wherein the flow channels create a flow path of alternating directions; and wherein the flow channels:
receive fluid flow from the plurality of entrance apertures;
direct the fluid flow from the entrance apertures in alternating directions through the flow channels to impart turning and frictional pressure loss to the fluid flow; and
direct exiting fluid flow through the exit apertures into the tubelane region of the steam generator.

2. The flow conditioning device of claim 1, wherein the outer enclosure is structurally attached to a tube support plate of the steam generator.

3. The flow conditioning device of claim 2, wherein the outer enclosure comprises threaded fasteners to structurally attach the outer enclosure to the tube support plate of the steam generator.

4. The flow conditioning device of claim 2, wherein the outer enclosure is structurally attached to the tube support plate by hydraulic expansion.

5. The flow conditioning device of claim 2, wherein the outer enclosure is structurally attached to the tube support plate by an interference fit.

6. The flow conditioning device of claim 2, wherein the outer enclosure comprises alignment or support features to orient, support, or facilitate attachment of the outer enclosure to the tube support plate.

7. The flow conditioning device of claim 6, wherein the alignment features comprise support pins, support inlet tubes, or matched holes.

8. The flow conditioning device of claim 6, wherein the support features comprise contact surfaces on the outer enclosure.

9. The flow conditioning device of claim 1, wherein the plurality of entrance apertures defined by the outer enclosure are configured to align or interface with matching flow holes defined by the tube support plate.

10. A method for increasing the local hydraulic resistance in a tubelane region of a nuclear power plant steam generator, the method comprising:
receiving fluid flow from a plurality of entrance apertures defined by an outer enclosure, wherein the entrance apertures are arranged in an array, and wherein the entrance apertures are in fluid communication with the tubelane region of the steam generator;
directing the fluid flow from the entrance apertures in alternating directions through flow channels defined by a plurality of baffle plates defined within the outer housing;
imparting turning and frictional pressure losses to the fluid flow through the flow channels; and
directing exiting fluid flow through exit apertures into the tubelane region of the steam generator, wherein the plurality of exit apertures are defined by the outer enclosure, and wherein the plurality of exit apertures are arranged in an array.

11. The method of claim 10, further comprising structurally attaching the outer enclosure to a tube support plate of the steam generator.

12. The method of claim 11, further comprising structurally attaching the outer enclosure to the tube support plate of the steam generator with threaded fasteners.

13. The method of claim 11, further comprising structurally attaching the outer enclosure to the tube support plate of the steam generator by hydraulic expansion.

14. The method of claim 11, further comprising structurally attaching the outer enclosure to the tube support plate of the steam generator by an interference fit.

15. The method of claim 11, further comprising structurally attaching the outer enclosure to the tube support plate of the steam generator by aligning the outer enclosure to the outer enclosure to the tube support plate.

16. The method of claim 15, further comprising aligning the outer enclosure to the outer enclosure to the tube support plate with support pins, support inlet tubes, or matched holes.

17. The method of claim 15, further comprising aligning the outer enclosure to the outer enclosure to the tube support plate with contact surfaces on the outer enclosure.

18. The method of claim 10, further comprising aligning or interfacing the plurality of entrance apertures defined by the outer enclosure with matching flow holes defined by the tube support plate.
